(19) United States
(12) Patent Application Publication
(10) Pub. No.: US 2013/0086352 A1
(43) Pub. Date: Apr. 4, 2013

(54) DYNAMICALLY CONFIGURABLE STORAGE DEVICE

(71) Applicant: Samsung Electronics Co., Ltd, Gyeonggi-do (KR)

(72) Inventor: Tirumala Surya Prasad Annepu, Bangalore (IN)

(73) Assignee: Samsung Electronics Co., Ltd, Gyeonggi-do (KR)

(21) Appl. No.: 13/631,535

(22) Filed: Sep. 28, 2012

(30) Foreign Application Priority Data
Sep. 30, 2011 (IN) 3398/CHE/2011

(51) Int. Cl. G06F 12/06

(52) U.S. Cl. 711/170; 711/E12.084

(57) ABSTRACT

A method dynamically configures resources in a storage device. The method includes determining a requirement for supplementary resources for processing upcoming storage specific commands associated with at least one of a plurality of logical unit in the storage device. The method also includes identifying type of supplementary resources required for the logical unit. Furthermore, the method includes determining whether unused resources of the identified resource type present in a common pool of resources shared between a plurality of logical units, and dynamically configuring the common pool of resources among the plurality of logical units such that the unused resources of the identified resource type present in the common pool of resources are allocated to the logical unit as supplementary resources for processing the upcoming storage specific commands.

### CROSS-REFERENCE TO RELATED APPLICATION(S) AND CLAIM OF PRIORITY

The present application is related to and claims priority under 35 U.S.C. §119(a) to a Indian Patent Application filed in the Indian Patent Office on Sep. 30, 2011 and assigned Serial No. 3398/CHE/2011, the content of which is incorporated herein by reference.

### TECHNICAL FIELD OF THE INVENTION

The present disclosure generally relates to data storage devices, and more particularly relates to configuring resources in storage devices.

### BACKGROUND OF THE INVENTION

Storage device such as flash memory is a non-volatile memory that can be electrically erased and re-programmed. Flash memory is typically used in Universal Flash Storage (UFS), Solid State Drive (SSD) cards, memory cards and Universal Serial Bus (USB) flash drives and so on for storage of data. Flash memory devices are one of the most adaptable portable electronic products due to its data non-volatility, low power consumption, small-volume, and non-mechanical structure.

Typically, a storage device comprises a controller and a physical memory for storing data files. The controller comprises firmware, a device manager, a task router, a target port, a plurality of resources (both hardware and software) and a plurality of logical units (also known as partitions). When a storage device is connected to a host device (e.g., mobile phone, smart phone, tablet computer, etc), logical units in the storage device are accessed by different applications running on the host system. Therefore, each logical unit in the storage device needs to process storage specific commands (e.g., inquiry command, report command, read command, write command, etc.) that are issued by the host device. Each logical unit is allocated a set of resources from a common pool of resources for processing the storage specific commands.

Currently, the host device configures fixed set of resources from the common pool of resources to each of the logical units in the storage device. While the resources allocated to the logical units are fixed, load on each of the logical units keeps varying depending on the kind of application accessing each of the logical units. For example, a video player on the host device may be attempting to read a huge amount of data from a particular logical unit while a file downloader on the host device may be attempting to write data to another logical unit simultaneously with the reading process at a slow data rate. The logical unit processing the read commands from the video player may require large number of resources while the logical unit processing write commands from the file downloader may require less number of resources. Thus, the load on both logical units is different and may dynamically vary based on type of application accessing the logical units. This may significantly affect the performance of the storage device and eventually affect the applications running on the host device.

### SUMMARY OF THE INVENTION

The present disclosure provides a method for dynamically configuring resources in a storage device. In one embodiment, a method includes predicting a load on a logical unit based on a set of parameters and determining a requirement for supplementary resources for processing upcoming storage specific commands associated with the logical unit based on the predicted load. The method also includes identifying type of supplementary resources required for the logical unit. Furthermore, the method includes determining whether there are any unused resources of the identified resource type in a common pool of resources shared between a plurality of logical units, and dynamically configuring the common pool of resources among the plurality of logical units such that the identified unused resources are allocated to the logical unit as supplementary resources for processing the upcoming storage specific commands.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device maybe implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram of a computing environment including a host device and a dynamically configurable storage device, according to one embodiment;

FIG. 2 illustrates an exemplary method of dynamically configuring resources allocated to logical units in the storage device, according to one embodiment; and

FIG. 3 illustrates a block diagram of a controller such as illustrated in FIG. 1, according to one embodiment.

The drawings described herein are for illustration purposes only and are not intended to limit the scope of the present disclosure in any way.

### DETAILED DESCRIPTION OF THE INVENTION

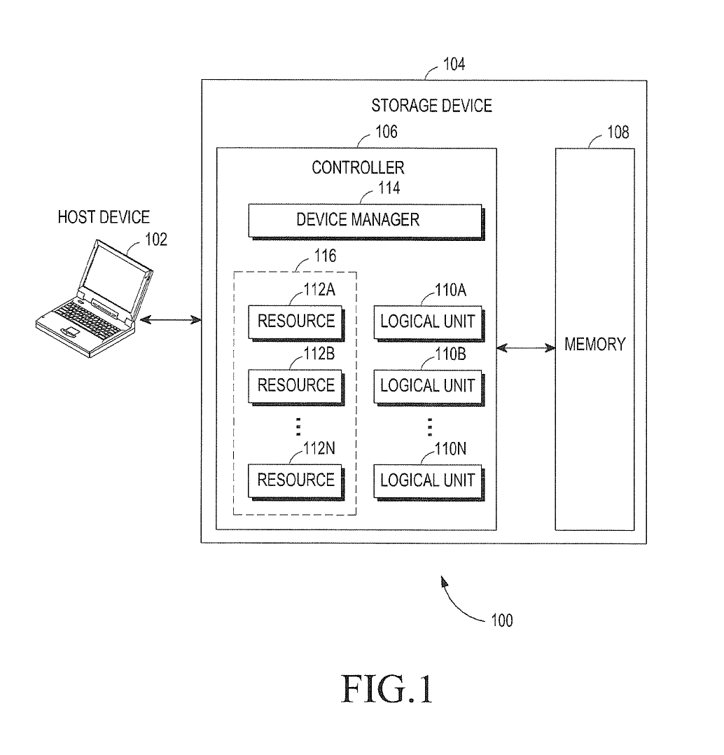

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The present disclosure provides a method for dynamically configuring a storage device. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments maybe utilized and that changes maybe made without departing from the scope of the present disclosure. The following detailed description is, therefore, not to be taken in a limiting sense, and the scope of the present disclosure is defined only by the appended claims.

FIG. 1 illustrates a block diagram of a computing environment 100 including a host device 102 and a dynamically configurable storage device 104, according to one embodiment. The host device 102 may be a personal computer, smart phone, mobile phone, digital camera, video recorder, tablet computer, personal digital assistant and the like. The storage device 104 may be Universal Flash Storage (UFS), Solid State Drive (SSD) cards, memory cards and Universal Serial Bus (USB) flash drives, and so on. The storage device 104 includes a controller 106 and a memory 108. The controller 106 includes logical units 110A-N, common pool 116 of resources 112A-N and a device manager 114. The common pool 116 of resources 112A-N may include hardware resources and/or software resources such as unified or command queue, return channel queue, cache, etc. Each of the logical units 110A-N are allocated one or more resources of a specific type from the common pool 116 of resources 112A-N. Each of the logical units 110A-N processes incoming and outgoing storage specific commands received or to be sent from/to the host device 102 using the allocated resource(s).

In an exemplary operation, each of the logical units 110A-N is configured for predicting a future load using a set of associated parameters. In some embodiments, each of the logical units 110A-N is configured for predicting the future load based on the principle of spatial locality. The principle of spatial locality is a technique through which type and number of upcoming storage specific commands can be predicted based on the received storage specific commands. For example, a logical unit determines that there are more incoming read commands and predicts that next command that can be received from the host device 102 would be a read command.

If the predicted load is greater than the threshold load, each of logical units 110A-N is configured for sending a request to the device manager 114 for allocating supplementary resources of a specific type (e.g., unified queue, return channel queue, etc.) for processing upcoming storage specific commands. The device manager 114 determines availability of unused resources in the common pool 116 of resources. For example, the logical unit 110A may request the device manager 114 for allocating return channel queue slots based on the predicted load. Accordingly, the device manager 114 checks availability of unused return channel queue slots with the logical units 110B-N. Each of the logical units 110B-N may predict future load based on set of parameters (e.g., commands being processed, number of used return channel queue slots, total number of allocated return channel queue slots) based on the principle of spatial locality and send a response indicating availability/non-availability of unused return channel queue slots to the device manager 114.

If the unused resources of a specific type are available, the device manager 114 re-allocates the unused resources of the specific type to the one or more of the logical units 110A-N and notifies change in configuration of the common pool 116 of resources to the logical units 110A-N. In some embodiments, the device manager 114 notifies the host device 102 regarding request for allocating supplementary resources from one or more of the logical units 110A-N using events. The host device 102 may grant or deny the allocation of supplementary resources to the one or more of the logical units 110A-N. If the host device 102 grants allocation of supplementary resources, the device manager 114 re-allocates the unused resources of the specific type to the one or more of the logical units 110A-N. Accordingly, the host device 102 and the logical units 110A-N can utilize the re-allocated resources for processing storage specific commands.

In an alternate embodiment, the device manager 114 may be configured for dynamically determining unused resources of the specific type in the common pool 116 of resources and allocating the unused resources of the specific type to the one or more of the logical units 110A-N. In this example, the device manager 114 need not check with the logical units 110A-N regarding the availability of unused resources rather keep track of the unused resources available in the common pool 116 of resources so that unused resources of the specific type can be dynamically allocated when needed.

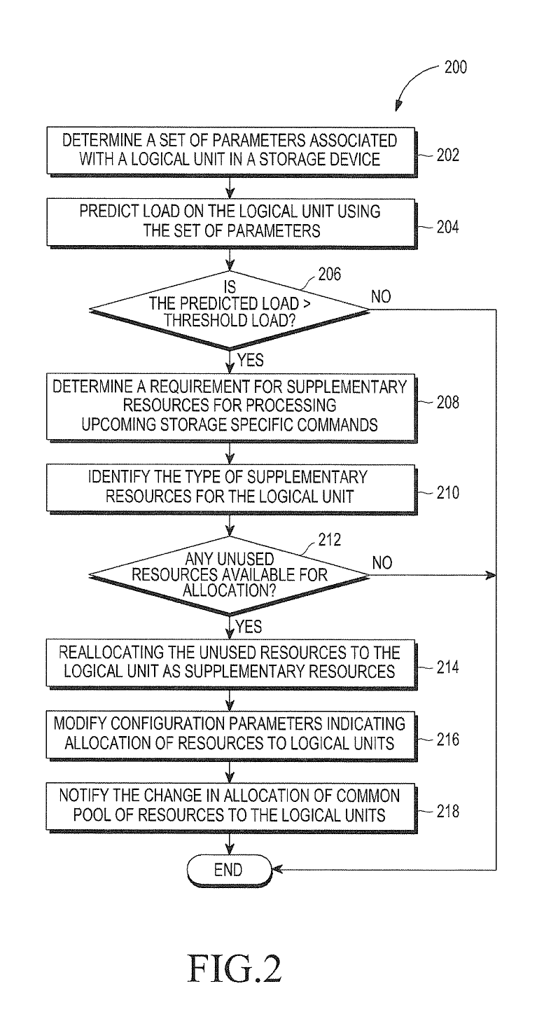

FIG. 2 illustrates an exemplary method 200 of dynamically configuring resources allocated to the logical units 110A-N in the storage device 104, according to one embodiment. At step 202, a set of parameters associated with a logical unit (e.g., the logical unit 110A) is determined during the runtime of the storage device 100. For example, the set of parameters may include number of storage specific commands being processed by the logical unit 110A, a type of storage specific commands being processed by the logical unit 110A, number of resources being utilized by the logical unit 110A in processing the storage specifics commands, and total number of resource allocated to the logical unit 110A. At step 204, a load on the logical unit 110A is determined based on the set of parameters. At step 206, it is determined whether the predicted load on the logical unit 110A is equal to or greater than a threshold load. If the predicted load is equal to or greater than the threshold load, then at step 208, a requirement for supplementary resources (e.g., hard ware resources and software resources) for the logical unit 110 A to process upcoming storage specific commands is determined. The requirement for supplementary resources refers to a need for additional resources (e.g., hardware resources and software resources) that would be required for processing upcoming commands by the logical unit 110A. If the predicted load is less than the threshold load, then the process is terminated.

At step 210, a type of supplementary resources required for processing the upcoming storage specific commands by the logical unit 110A is identified. At step 212, it is determined whether there are any unused resources of the identified resources type in a common pool 116 of resources currently shared between the logical units 110A-N. If there are unused resources in the common pool 116 of resources, then at step 214, one or more of the unused resources of the identified resource type that are currently allocated to other logical units 110B-N are re-allocated to the logical unit 110A so that the logical unit 110A processes the upcoming storage specific commands using the re-allocated resources. If there are no unused resources in the common pool 116 of resources, the process 200 is terminated. Upon re-allocating the unused resources to the logical unit 110A, the host device 102 may be notified regarding change in allocation of resources. For example, the host device 102 may be notified when allocation of resources such command queue slots is altered. The host device 102 may accept or reject the re-allocation of unused resources to the logical unit 110A.

At step 216, configuration parameters indicating allocation of resources to the logical units 110A-N are modified. In one exemplary implementation, the configuration parameters stored in a configuration file (e.g., descriptor file or register file) of the storage device 104 is modified. At step 218, change in allocation of common pool 116 of resources is notified to the logical units 110A-N. Accordingly, the logical units 110A-N read the modified configuration parameters from the configuration file and processes current and upcoming storage specific commands using resources as per the modified configuration parameters.

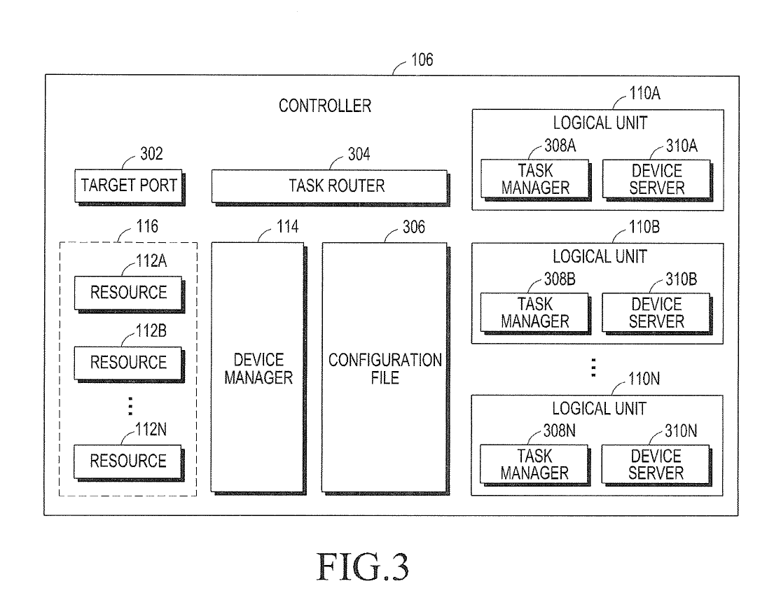

FIG. 3 illustrates a block diagram of the controller 106 illustrated in FIG. 1, according to one embodiment. As shown in FIG. 3, the controller 106 includes the logical units 110A-N, the common pool 116 of resources 112A-N, the device manager 114, a target port 302, a task router 304, and a configuration file 306. The logical units 110A-N include task managers 308A-N and device servers 310A-N, respectively.

For example, the task router 304 is configured for routing storage specific commands received from the host device 102 via the target port 302 to respective logical units 110A-N. The device servers 310A-N in the logical units 110A-N process the respective storage specific commands and generates a response for the host device 102. The task managers 308A-N and/or the device servers 310A-N in the logical units 110A-N are configured for predicting future load using a set of parameters (e.g., resources being utilized, total number of allocated resources, and storage specific command being processed) based on principle of spatial locality. The task managers 308A-N are configured for dynamically determining whether there is a need for supplementary resources of a specific type for processing upcoming storage specific commands.

If there is a need for supplementary resources, then each of the task managers 308A-N is configured for sending a request for supplementary resources to the device manager 114. The device manager 114 is configured for determining availability of unused resources of the specific type with one or more of the logical units 110A-N. The device manager 114 is also configured for allocating one or more of the unused resources of the specific type from the common pool 116 of resources as supplementary resources to requested logical units 110A-N for processing the upcoming storage specific commands.

The device manager 114 is further configured for updating configuration file 306 indicating allocation of resources to the logical units 110A-N with new configuration parameters. Furthermore, the device manager 114 is configured for notifying the change in the configuration of the common pool 116 of resources to the host device 102 and the logical units 110A-N. Accordingly, the task managers 308A-N in the respective logical units 110A-N are configured for processing upcoming storage specific commands as per the updated configuration of the common pool 116 of resources in the configuration file 306.

It can be noted that, in some embodiments, the task router 304 can also be configured for determining availability of unused resources of the specific type with one or more of the logical units 110A-N upon receiving the request for supplementary from the one or more logical units 110A-N and allocating one or more of the unused resources of the specific type from the common pool 116 of resources to the requested logical units 110A-N.

The present embodiments have been described with reference to specific example embodiments, it will be evident that various modifications and changes may be made to these embodiments without departing from the broader spirit and scope of the various embodiments. Furthermore, the various devices, modules, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as application specific integrated circuit.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for dynamically configuring resources in a storage device, the method comprising:
determining a requirement for supplementary resources for processing upcoming storage specific commands associated with at least one of a plurality of logical units in the storage device;
identifying a type of supplementary resources required for processing the upcoming storage specific commands associated with the at least one of the plurality of logical units;
determining whether unused resources of the identified resource type present in a common pool of resources shared among the plurality of logical units; and
dynamically configuring the common pool of resources among the plurality of logical units such that one or more of the unused resources of the identified resource type present in the common pool of resources are allocated to the at least one of the plurality of logical units as supplementary resources for processing the upcoming storage specific commands.

2. The method of claim 1, wherein determining the requirement for supplementary resources for processing the upcoming storage specific commands associated with the at least one logical unit in the storage device comprises:
predicting a load on the at least one logical unit based on a set of parameters associated with the at least one logical unit;
determining whether the predicted load on the at least one logical unit is equal to or greater than threshold load; and
determining a requirement for supplementary resources for processing upcoming storage specific commands associated with the at least one logical unit in response to determining that the predicted load on the at least one logical unit is equal to or greater than the threshold load.

3. The method of claim 2, wherein the set of parameters comprises a number of storage specific commands being processed by the at least one logical unit, a type of the storage specific commands being processed by the at least one logical unit, a number of resources being utilized by the at least one logical unit for processing the storage specific commands, and a total number of resources allocated to the at least one logical unit.

4. The method of claim 1, wherein the unused resources comprise resources currently allocated to remaining logical units of the plurality of logical units in the storage device.

5. The method of claim 1, wherein dynamically configuring the common pool of resources among the plurality of logical units comprises:
dynamically allocating one or more of the unused resources from the common pool of resources to the at least one of the plurality of logical units.

6. The method of claim 1, further comprising:
notifying a host device regarding the dynamic configuration of the common pool of resources.

7. The method of claim 6, wherein dynamically configuring the common pool of resources among the plurality of logical units comprises:
dynamically configuring the common pool of resources among the plurality of logical units if the host device grants the dynamic configuration of the common pool of resources.

8. The method of claim 1, further comprising:
notifying the plurality of logical units of the dynamic configuration of the common pool of resources.

9. The method of claim 8, further comprising:
modifying configuration parameters corresponding to the dynamically configured common pool of resources.

10. The method of claim 9, further comprising:
reading the modified configuration parameters corresponding to the dynamically configured common pool of resources by each of the plurality of logical units.

11. An apparatus comprising:
a controller;
a plurality of logical units;
a common pool of resources; and
a memory communicatively coupled to the controller, wherein the controller is configured to:
determine a requirement for supplementary resources for processing upcoming storage specific commands associated with at least one of the plurality of logical units;
identify a type of supplementary resources required for processing the upcoming storage specific commands associated with the at least one of the plurality of logical units;
determine whether unused resources of the identified resource type are present in the common pool of resources shared among the plurality of logical units; and
dynamically configuring the common pool of resources among the plurality of logical units such that one or more of the unused resources of the identified resource type present in the common pool of resources are allocated to the at least one of the plurality of logical units as supplementary resources for processing the upcoming storage specific commands.

12. The apparatus of claim 11, wherein in determining the requirement for supplementary resources for processing the storage specific commands associated with the at least one logical unit in the storage device, the controller is configured to:
predict a load on the at least one logical unit based on a set of parameters associated with the at least one logical unit;
determine whether the predicted load on the at least one logical unit is equal to or greater than threshold load; and
determine a requirement for supplementary resources for processing the upcoming storage specific commands associated with the at least one logical unit in response to determining that the predicted load on the at least one logical unit is equal to or greater than the threshold load.

13. The apparatus of claim 12, wherein the set of parameters comprises a number of storage specific commands being processed by the at least one logical unit, a type of the storage specific commands being processed by the at least one logical unit, a number of resources being utilized by the at least one logical unit for processing the storage specific commands, and a total number of resources allocated to the at least one logical unit.

14. The apparatus of claim 11, wherein the unused resources comprises resources currently allocated to remaining logical units of the plurality of logical units.

15. The apparatus of claim 11, wherein in dynamically configuring the common pool of resources among the plurality of logical units, the controller is configured to:
dynamically allocate one or more of the unused resources from the common pool of resources to the at least one of the plurality of logical units.

16. The apparatus of claim 11, wherein the controller is configured to:
notify a host device regarding the dynamic configuration of the common pool of resources.

17. The apparatus of claim 16, wherein in dynamically configuring the common pool of resources among the plurality of logical units, the controller is configured to:
dynamically configure the common pool of resources among the plurality of logical units if the host device grants the dynamic configuration of the common pool of resources.

18. The apparatus of claim 11, wherein the controller is configured to:
notify the dynamic configuration of the common pool of resources to the plurality of logical units.

19. The apparatus of claim 18, wherein the controller is configured to:
modify configuration parameters corresponding to the dynamically configured common pool of resources.

20. The apparatus of claim 19, wherein the controller is configured to:
read the modified configuration parameters corresponding to the dynamically configured common pool of resources by each of the plurality of logical units.

21. A non-transitory computer-readable storage medium with an executable program stored thereon, wherein the program comprises instruction that, when executed, instruct a controller in a storage device to:
determine a requirement for supplementary resources for processing upcoming storage specific commands associated with at least one of a plurality of logical units of the storage device;
identify a type of supplementary resources required for processing the upcoming storage specific commands associated with the at least one of the plurality of logical units;
determine whether unused resources of the identified resource type present in the common pool of resources shared among the plurality of logical units; and
dynamically configure the common pool of resources among the plurality of logical units such that one or more of the unused resources of the identified resource type present in the common pool of resources are allocated to the at least one of the plurality of logical units as supplementary resources for processing the upcoming storage specific commands.

22. The storage medium of claim 21, wherein the instructions that instruct the controller to determine the requirement for supplementary resources for processing the upcoming storage specific commands associated with the at least one logical unit in the storage device, comprise instructions that instruct the controller to:
predict a load on the at least one logical unit based on a set of parameters associated with the at least one logical unit;
determine whether the predicted load on the at least one logical unit is equal to or greater than threshold load; and
determine a requirement for supplementary resources for processing the upcoming storage specific commands associated with the at least one logical unit in response to determining that the predicted load on the at least one logical unit is equal to or greater than the threshold load.

23. The storage medium of claim 21, wherein wherein the instructions that instruct the controller to dynamically configure the common pool of resources among the plurality of logical units, comprise instructions that instruct the controller to:
dynamically allocate one or more of the unused resources from the common pool of resources to the at least one of the plurality of logical units.

24. The storage medium of claim 21, wherein the program comprises instructions to instruct the controller to:
notify a host device regarding the dynamic configuration of the common pool of resources.

25. The storage medium of claim 24, wherein wherein the instructions that instruct the controller to dynamically configure the common pool of resources among the plurality of logical units, comprise instructions that instruct the controller to:
dynamically configure the common pool of resources among the plurality of logical units if the host device grants the dynamic configuration of the common pool of resources.

26. The storage medium of claim 21, wherein the program comprises instructions to instruct the controller to:
notify the dynamic configuration of the common pool of resources to the plurality of logical units.
